(19) United States
(12) Patent Application Publication
(10) Pub. No.: US 2019/0057072 A1
(43) Pub. Date: Feb. 21, 2019

(54) METHOD, DEVICE AND ELECTRONIC EQUIPMENT FOR SWITCHING NAME OF DESKTOP ICON FOLDER

(71) Applicant: YULONG COMPUTER TELECOMMUNICATION SCIENTIFIC (SHENZHEN) CO., LTD., Shenzhen (CN)

(72) Inventor: XIAO-ZHOU WANG, Shenzhen (CN)

(73) Assignee: YULONG COMPUTER TELECOMMUNICATION SCIENTIFIC (SHENZHEN) CO., LTD., Shenzhen (CN)

(21) Appl. No.: 16/081,414

(22) PCT Filed: Sep. 29, 2016
(86) PCT No.: PCT/CN2016/100699

§ 371 Date: Aug. 30, 2018

(30) Foreign Application Priority Data
Mar. 1, 2016 (CN) 201610116119.4

(51) Int. Cl. G06F 17/24; G06F 3/0481; G06F 3/0482

(52) U.S. Cl. CPC G06F 17/241; G06F 3/0482; G06F 3/04817

(57) ABSTRACT

A method, a deviceand electronic equipment for switching a name of a desktop icon folder are disclosed. The method includes: detecting a preset event (101); when the preset event is detected, control starting of a folder name switching process (102), which includes: firstly determining a system language used by current equipment (103); searching for a folder name corresponding to a language category of the system language from data of desktop icon folder names previously input by a user (104); when the folder name is found, switching a name of a desktop icon folder to the folder name corresponding to the language category of the system language (105). The method, the device and the electronic equipment can automatically determine the system language periodically or triggered by other preset events, according to preset configurations; and control an adaptive change of the name of the desktop icon folder according to a determination result, to make a changed name of the desktop icon folder be coordinated and consistent with names of other icons and be conveniently for the user to use.

### CROSS-REFERENCE TO RELATED APPLICATIONS

This application claims priority of Chinese Patent Application No. 201610116119.4, entitled “method, device and electronic equipment for switching a name of a desktop icon folder,” filed on Mar. 1, 2016 in the SIPO (State Intellectual Property Office of the People's Republic of China), the entire contents of which are incorporated by reference herein.

### FIELD

The embodiments of the present disclosure relates to a technical field of data processing, specifically a method, a device and electronic equipment for switching a name of a desktop icon folder.

### BACKGROUND

With wide popularization of intelligent terminals and development of technology, various kinds of terminal applications are also developed. A user terminal has more and more various applications (APPS), thus, a terminal system is required to provide a better method for managing a plurality of applications. Therefore, creating automatically or customizing a folder on a terminal desktop and naming the folder customized is a terminal technology that is widely applied in recent years.

In prior art, almost all intelligent terminals have a function of adding desktop icon folders. When creating a folder, a user can name the folder, and a name of the folder is displayed in a language corresponding to a language category of a current language system. However, when the terminal switches the language system, or example, when a current Chinese language system is switched to an English language system, names of,tiles or applications of the system can be switched to corresponding language names to display along with a change of the language system, but a name of a folder created or customized by the user cannot be changed along with a switching of the language system of the terminal. That is, before and after switching the language system of the terminal, a name of an icon folder created or customized by the user is displayed as a same name when the icon folder is created. Accordingly, the name of the icon folder created or customized by the user displayed on the terminal desktop is not coordinated with names of other application icons on the terminal desktop, and it is inconvenience for using by the user of the terminal.

### SUMMARY

In view of the above, the present disclosure provides a method, a device and electronic equipment for switching a name of a desktop icon folder, for overcoming a problem that a displayed name of a desktop icon folder is not coordinated with names of other icons and it is not inconvenient for using by a user, and the problem is caused because the displayed name of the desktop icon folder, which is created or customized by a user, cannot be adaptively changed along with switching of a terminal language system in the prior art.

In order to achieve the purpose, the present disclosure provides a technical solution as follows:

A method for switching a name of a desktop icon folder, includes:

Starting a folder name switching process when a preset event is detected;

The folder name switching process includes:

Determining a system language used by current equipment;

Searching for a folder name corresponding to a language category of the system language from data of desktop icon folder names previously input by a user;

When the folder name is found, switching a name of a desktop icon folder from a first name to a second name, language categories of the first name and the second name being different, and the second name being the folder name corresponding to the language category of the system language.

Optionally, the method further includes:

Acquiring at least one group of folder name data input by the user when creating the desktop icon folder or modifying a folder name, the at least one group of folder name data including language category information, and a corresponding folder name;

Optionally, the at least one group of folder name data includes folder name data corresponding to a language category of a default system language.

Optionally, the method further includes: when no folder name corresponding to the language category of the system language is found, switching the name of the desktop icon folder to a folder name corresponding to the language category of the default system language;

Optionally, the preset event includes that:

A system periodic time node is reached, the system starts or executes a system language switching operation.

A device for switching a name of a desktop icon folder, includes:

A detection module configured to detect a preset event;

A process control module configured to control starting of a folder name switching process, when the detection module detects the preset event;

A process execution module configured to execute the folder name switching, process, including a language determination module, a name searching module and a name switching module, in which:

The language determination module is configured to determine a system language used by current equipment;

The name searching module is configured to search for a folder name corresponding to a language category of the system language from data of desktop icon folder names previously input by a user;

The name switching module is configured to switch a name of a desktop icon folder from a first name to a second name when the name searching module finds the folder name corresponding to the language category of the system language, language categories of the first name and the second name being different, and the second name being the folder name corresponding to the language category of the system language.

Optionally, the device further includes:

A name acquisition module configured to acquire at least one group of folder name data input by the user when creating the desktop icon folder or modifying a folder name, the at least one group of folder name data including language category information and a corresponding folder name;

Optionally, the at least one group of folder name data includes folder name data corresponding to a language category of a default system language.

Optionally, the name switching module is further configured to: switch the name of the desktop icon folder to a folder name corresponding to the language category of the default system language, when the name searching module does not found any folder name corresponding to the language category of the system language.

Optionally, the detection module is specifically configured to: detect whether an event that a system periodic time node is reached, the system starts or executes a system language switching operation, is occurred.

Electronic equipment includes any of the above mentioned device for switching a name of a desktop icon folder.

According to the above technical solution, compared with the prior art, it can be known that, embodiments of the present disclosure disclose a method, a device and electronic equipment for switching a name of a desktop icon folder. When a preset event is detected, the method for switching a name of a desktop icon folder can control starting of a folder name switching process, including: determining a system language used by current equipment firstly; searching for a folder name corresponding to a language category of the system language from data of desktop icon folder names previously input by a user, and switching a name of a desktop icon folder to the folder name corresponding to the language category of the system language when the folder name is found. The method, the device and the electronic equipment for switching a name, of a desktop icon folder can automatically determine the system language periodically or triggered by other preset events, according to preset configurations; and control an adaptive change of the name of the desktop icon folder according to a determination result, to make a changed name of the desktop icon folder be coordinated and consistent with names of other icons and be conveniently for the user to use.

### BRIEF DESCRIPTION OF THE DRAWINGS

In order to describe the technical solutions in the embodiments of the present disclosure or the prior art more clearly, the following briefly introduces the accompanying drawings needed for describing the embodiments or the prior art, obviously, the accompanying drawings in the following description merely show some embodiments of the present disclosure, and persons of ordinary skill in the art may derive other drawings from these accompanying drawings without creative efforts.

FIG. 1 is a flowchart of a method for switching a name of a desktop icon folder according to an embodiment of the present disclosure:

FIG. 2 is another flowchart of a method for switching a name of a desktop icon folder according to an embodiment of the present disclosure;

FIG. 3 is a schematic diagram of a display window of naming a folder user-defined according to an embodiment of the present disclosure;

FIG. 4 is a third flowchart of a method for switching a name of a desktop icon folder according to an embodiment of them present disclosure;

FIG. 5 is a schematic structural diagram of a device for switching a name of a desktop icon folder according to an embodiment of the present disclosure;

FIG. 6 is another schematic structural diagram of a device for switching a name of a desktop icon folder according to an embodiment of the present disclosure.

FIG. 7 is a schematic structural diagram of electronic equipment according to an embodiment of the present disclosure.

### DETAILED DESCRIPTION

With the accompanying drawings in the embodiments of the present disclosure described below, the technical solution in the embodiment of the present disclosure is clearly and completely described, apparently, the described embodiments are merely a part of the embodiments of the present disclosure rather than all embodiments. Based on the embodiments of the present disclosure, all other embodiments acquired by persons of ordinary skill in the art without creative efforts shall fall within the protection scope of the present disclosure.

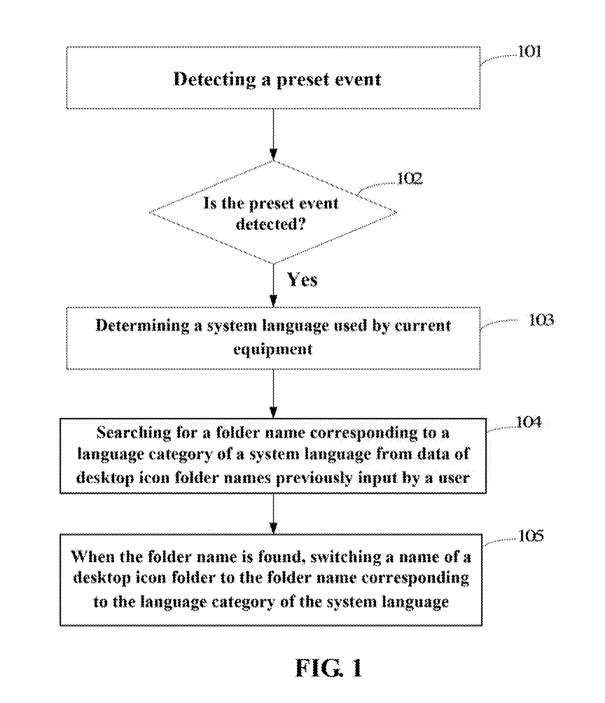

Referring to FIG. 1, which is a flowchart of a method for switching a name of a desktop icon folder according to an embodiment of the present disclosure, the desktop icon folder can be a folder created by a user, namely a desktop launcher icon folder, or can be a folder created by a system. As shown in FIG. 1, the method can include:

Step 101: detecting a preset event;

The preset event can include that, but is not limited to, a system periodic time node is reached, the system starts or executes a system language switching operation. In a practical application scene, corresponding preset events can be configured according to requirements.

The system periodic time node can be configured to be a fixed time node, such as each time point, 1 o'clock, 2 o'clock and the like; also can be configured to execute a folder name switching process every fixed time period, after the electronic, equipment is started.

When starting the system, some electronic equipment can select a system language to be used after the system is started. If the user updates a previously adopted system language when the electronic equipment is started, a corresponding language switching needs to be executed on the name of the desktop icon folder for displaying, after the system is started successfully. In a normal operation process of the electronic equipment, if a system language switching operation occurs, a folder name switching action is directly triggered for displaying.

Step 102, determining whether the preset vent is detected; if yes, starting a folder name switching process, and entering step 103;

When the system detects that the above preset event occurs, including that the system periodic time node is reached, or the system starts or the system executes the system language switching operation, the folder name switching process can be started. A detailed procedure of the folder name switching process can be referred to step 103-105.

If no preset event is detected, no operation is performed.

Step 103, determining a system language used by current equipment;

When the folder name switching process needs to be performed, the system language adopted by the current equipment needs to be determined first, then a folder name matched with the corresponding system language can be conveniently found and controlled to display.

Step 104, searching for the folder name corresponding to a language category of the system language from data of desktop icon folder names previously input by the user.

A precondition of an implementation of the step 104 is that a folder name corresponding to the language category of the current system language has been stored in the system, for example, the current system language is English, an English name of the folder has been stored in the system. Specifically, when the system language is Chinese, the user creates a desktop icon folder and gives it a user-defined name as “ [symbol] ”, and also gives it a corresponding user-defined English name as “Leisure Time.” When the system language is switched from Chinese to English, the system can search for the English name corresponding to the desktop icon folder, namely, the folder name of “Leisure Time” can be found.

Step 105, under the condition that the folder name is found in step 104, switching the name of the desktop icon folder from a first name to a second name.

The first name and the second name are different in language category; and the second name is a folder name corresponding to the language category of the system language. The first name is the folder name before the preset event is detected.

After the folder name corresponding to the system language is found in step 104, the system can control the found folder name to be displayed at a name display position of the corresponding folder, thereby completing a switching of the folder name.

In one embodiment, when a preset event is detected, the method for switching a name of a desktop icon folder can control starting of a folder name switching process, including: determining a system language used by current equipment firstly; searching for a folder name corresponding to a language category of the system language from data of desktop icon folder names previously input by a user, and switching a name of a desktop icon folder to the folder name corresponding to the language category of the system language when the folder name is found. The method, the device and the electronic equipment for switching a name of a desktop icon folder can automatically determine the system language periodically or triggered by other preset events, according to preset configurations; and control an adaptive change of the name of the desktop icon folder according to a determination result, to make a changed name of the desktop icon folder be coordinated and consistent with names of other icons and be conveniently for the user to use.

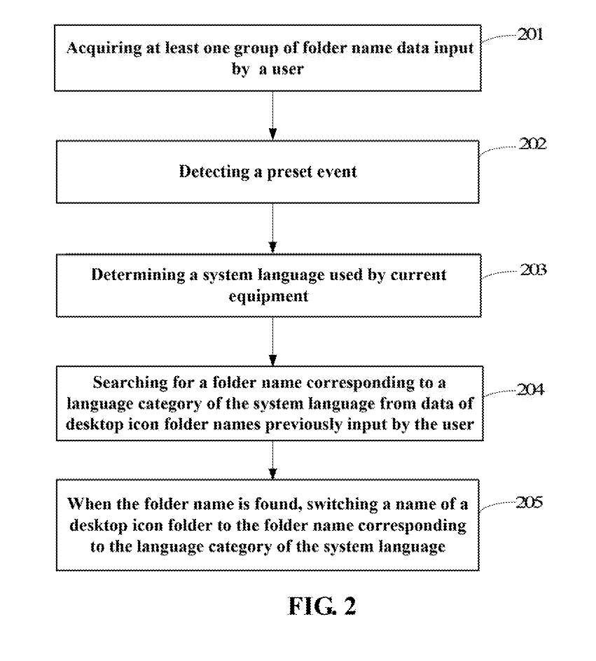

On the basis of the embodiments disclosed by the present disclosure, FIG. 2 shows another flowchart of a method for switching a name of a desktop icon folder, the desktop icon folder can be a folder created by a user, or can be a folder created by a system. As shown in FIG. 2, the method can include:

Step 201, acquiring at least one group of folder name data input by the user;

the at least one group of folder name data can include language category information and, corresponding folder names.

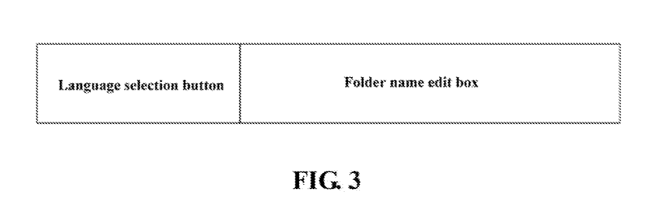

When the user initially creates a desktop icon folder or when the user modifies a name of the desktop icon folder later, the user can perform user-defined naming on the name of the desktop icon folder, thus the system can acquire folder name data input by the user. Specifically, FIG. 3 is a schematic diagram of a display window of naming a folder user-defined according to an embodiment of the present disclosure, the system can display two parts of contents in the display window of naming the folder user-defined, including a language selection button and a folder name edit box, the user can select a language by selecting the language selection button first, and then input a folder name corresponding to a type of the selected language in the folder name edit box behind. The user can select a plurality of languages in sequence and input folder names corresponding to the plurality of languages.

In an embodiment of the present disclosure, if the user names the folder user-defined, at least one group of folder name data needs to be input.

Step 202, when a preset event is detected, starting a folder name switching process, and then the procedure entering step 203;

As disclosed in the above embodiments, the preset event can include that, but is not limited to, the system periodic time node is reached, the system starts or executes the system language switching operation. In a practical application scene, corresponding preset events can be configured according to requirements.

The specific process of the folder name switching process may refer to steps 203-205. As operations of steps 203-205 are the same as steps 103-105 in the previous embodiment, introductions of related contents can be referred to contents in the first embodiment, and it is not repeated herein.

Step 203, determining a system language used by current equipment;

Step 204, searching for a folder name corresponding to a language category of the system language from data of desktop icon folder names previously input by the user.

Step 205, under the condition that the folder name is found in step 204, switching the name of the desktop icon folder from a first name to a second name.

The first name, and the second name are different in language category; and the second name is a folder name corresponding to the language category of the system language. The first name is the folder name before the preset event is detected.

In this embodiment, at least one group of folder name data input by the user is acquired first. When the system needs to execute a folder name switching process later, a matched folder name can be searched from data of folder name input by the user previously, and display of the folder name is controlled to switch under the condition that the matched folder name has been found, thereby controlling an adaptive change of a name of a desktop icon folder along with a change of the system language, to make a changed name of the desktop icon folder be coordinated and consistent with names of other icons and be conveniently for the user to use.

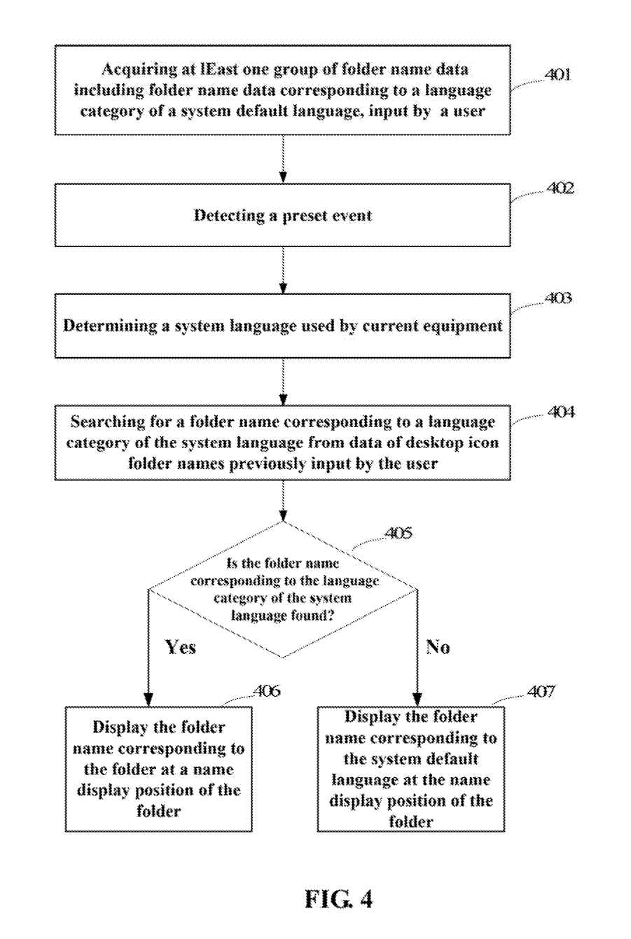

FIG. 4 is a third flowchart of a method for switching a name of a desktop icon folder according to an embodiment of the present disclosure, the desktop icon folder can be a folder created by a user, or can be a folder created by a system. As shown in FIG. 4, the method can include:

Step 401, acquiring at least one group of folder name data input by the user, the at least one group of folder name data including folder name data corresponding to a language category of a system default language;

the at least one group of folder name data can include language category information and corresponding folder names.

When the user initially creates a desktop icon folder or when the user modifies a name of the desktop icon folder later, the user can perform user-defined naming on the name of the desktop icon folder, thus the system can acquire folder name data input by the user.

The folder name data includes the folder name data corresponding to the language category of the system default language. In this embodiment, the folder name data corresponding to the system default language must be set, and folder name data corresponding to other non-default languages of the system can be selected partially or completely to set.

Step 402, when a preset event is detected, starting a folder name switching process, and then the procedure entering step 403;

Steps of the folder name switching process can be referred to steps 403-407.

Step 403, determining a system language used by current equipment;

Step 404, searching for a folder name corresponding to a language category of the system language from data of desktop icon folder names previously input by the user.

Step 405, determining whether the folder name corresponding to the language category of the system language is found; if the folder name is found, entering step 406; if the folder name is not found, entering step 407;

Step 406, switching the name of the desktop icon folder from a first name to a second name.

The first name and the second name are different in language category; and the second name is a folder name corresponding to the language category of the system language. The first name is the folder name before the preset event is detected.

Step 407, switching the name of the desktop icon folder to the folder name corresponding to the language category of the system default language.

Under the condition that the folder name corresponding to the system language is not found, a display of the folder name cannot be normally switched to a state matched with the current system language, at the moment, the system can control the name of the desktop icon folder to be switched to the folder name corresponding to the language category of the system default language.

For example, when the user inputs the folder name data, Chinese folder name data and English folder name data is input, and Chinese is the system default language. In this case, if the user switches the system language from original English to Japanese, at the moment, the system does not find the folder name data related to Japanese, an English name originally displayed by the folder is switched to be a Chinese name of the folder corresponding to the default language (Chinese) of the system.

Under the condition that the user merely inputs one group of folder name (the folder name corresponds to the language category of the system default language), when no folder name corresponding to the system language is found, the folder name is kept unchanged.

The method is described in detail in the above embodiments of the present disclosure, and the method of the present disclosure can be implemented by using a variety of devices, thus, the present disclosure further discloses a device, specific embodiment is described in detail below.

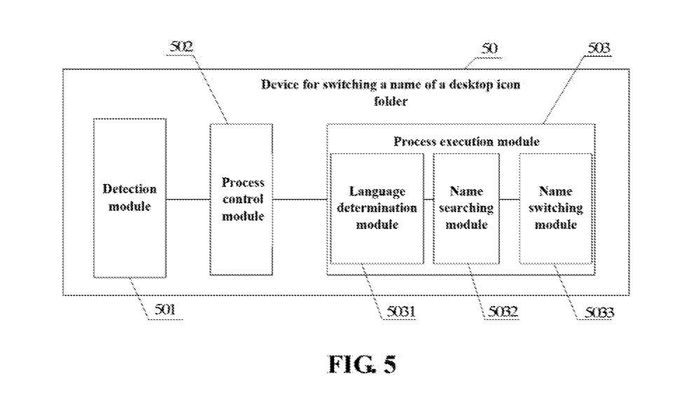

FIG. 5 is a schematic structural diagram of a device for switching a name of a desktop icon folder according to an embodiment of the present disclosure, the desktop icon folder can be a folder created by a user, or can be a folder created by a system As shown in FIG. 5, a device 50 for switching a name of a desktop icon folder can include:

A detection module 501, which is configured to detect a preset event;

The preset event can include that, but is not limited to, a system periodic time node is reached, the system starts or executes a system language switching operation. In a practical application scene, corresponding preset events can be configured according to requirements.

Thus, the detection module 501 can be specifically configured to: detect whether an operation event that the system periodic time node is reached, the system starts or executes the system language switching, has occurred.

A process control module 502 is configured to control starting the folder name switching process when the detection module 501 detects the preset event;

When the system detects that the above preset event occurs, including that the system periodic time node is reached, or the system starts or the system executes the system language switching operation, the folder name switching process can be started.

A process execution module 503 is configured to execute the folder name switching process; and specifically includes a language determination module 5031, a name searching module 5032 and a name switching module 5033, in which:

The language determination module 5031 is configured to determine a system language used by current equipment;

When the folder name switching process needs to be performed, the system language adopted by the current equipment needs to be determined first, then a folder name matched with the corresponding system language can be conveniently found and controlled to display.

The name searching module 5032 is configured to search for the folder name corresponding to a language category of the system language from data of desktop icon folder names previously input by the user;

In this embodiment, a folder name corresponding to a language category of a current system language is stored in the system, for example, the current system language is English, an English name of the folder has been stored in the system. Specifically, when the system language is Chinese, the user creates a desktop icon folder and gives it a user-defined name as “ [symbol] ”, and also gives it a corresponding user-defined English name as “Leisure Time.” When the system language is switched from Chinese to English, the system can search for the English name corresponding to the desktop icon folder, namely, the folder name of “Leisure Time” can be found.

The name switching module 5033 is configured to switch the name of the desktop icon folder from a first name to a second name, when the name searching module 5032 found the folder name corresponding to the language category of the system language.

The first name and the second name are different in language category; and the second name is a folder name corresponding to the language category of the system language. The first name is the folder name before the preset event is detected.

After the name searching module 5032 found the folder name corresponding to the system language, the name switching module 5033 can control the found folder name to be displayed at a name display position of the corresponding folder, thereby completing a switching of the folder name.

In one embodiment, when a preset event is detected, the device for switching a name of a desktop icon folder can control starting, of a folder name switching process, including: determining a system language used by current equipment firstly; searching for a folder name corresponding to a language category of the system language from data of desktop icon folder names previously input by a user, and switching a name of a desktop icon folder to the folder name corresponding to the language category of the system language when the folder name is found. The device for switching a name of a desktop icon folder can automatically determine the system language periodically or triggered by other preset events, according to preset configurations; and control an adaptive change of the name of the desktop icon folder according to a determination result, to make a changed name of the desktop icon folder be coordinated and consistent with names of other icons and be conveniently for the user to use.

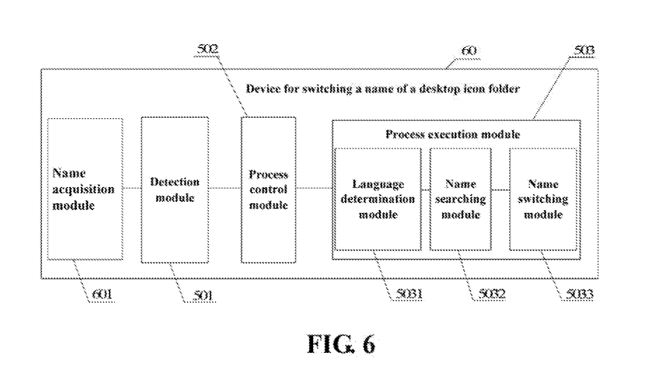

FIG. 6 discloses another schematic structural diagram of a device for switching a name of a desktop icon folder, the desktop icon folder can be a folder created by a user, or can be a folder created by a system. As shown in FIG. 6, a device 60 for switching a name of a desktop icon folder can include:

A name acquisition module 601, which is configured to acquire at least one group of folder name data input by the user, when creating a desktop icon folder or modifying a folder name;

the at least one group of folder name data can include language category information and corresponding folder names.

When the user initially creates a desktop icon folder or when the user modifies a name of the desktop icon folder later, the user can perform user-defined naming on the name of the desktop icon folder, thus the system can acquire folder name data input by the user.

In an embodiment of the present disclosure, if the user names the folder user-defined, at least one group of folder name data needs to be input.

The detection module 501 is configured to detect a preset event;

The preset event can include that, but is not limited to, a system periodic time node is reached, the system starts or executes a system language switching operation, in a practical application scene, corresponding preset events can be configured according to requirements.

The process control module 502 is configured to control starting the folder name switching process when the detection module 501 detects the preset event;

The process execution module 503 is configured to execute the folder name switching process; and includes the language determination module 5031, the name searching module 5032 and the name switching module 5033, in which:

The language determination module 5031 is configured to determine a system language used by current equipment;

The name searching module 5032 is configured to search for the folder name corresponding to a language category of the system language from data of desktop icon folder names previously input by the user;

The name switching module 5033 is configured to switch the name of the desktop icon folder from a first name to a second name, when the name searching module 5032 found the folder name corresponding to the language category of the system language.

The first name and the second name are different in language category; and the second name is a folder name corresponding to the language category of the system language. The first name is the folder name before the preset event is detected.

In this embodiment, at least one group of folder name data input by the user is acquired first. When the system needs to execute a folder name switching process later, a matched folder name can be searched from data of folder name input by the user previously, and display of the folder name is controlled to switch under the condition that the matched folder name has been found, thereby controlling an adaptive change of a name of a desktop icon folder along with a change of the system language, to make a changed name of the desktop icon folder be coordinated and consistent with names of other icons and be conveniently for the user to use

It should be noted that, in other embodiments, the name acquisition module 601 is specifically configured to acquire at least one group of folder name data including folder name data corresponding to a language category of a system default language input by the user. The folder name data can include language category information and a corresponding folder name.

The folder name data includes folder name data corresponding to the language category of the system default language. In this embodiment, the folder name data corresponding to the system default language must be set, and folder name data corresponding to other non-default languages of the system can be selectively set.

Subsequently, when the name searching module searches for the folder name corresponding to the language category of the system language, if the folder name is found, the name switching module controls the name of the desktop icon folder to be switched from a first name to a folder name corresponding to the language category of the system language. If the folder name is not found, the name switching module controls the name of the desktop icon folder to be switched to a folder name corresponding to the language category of the system default language.

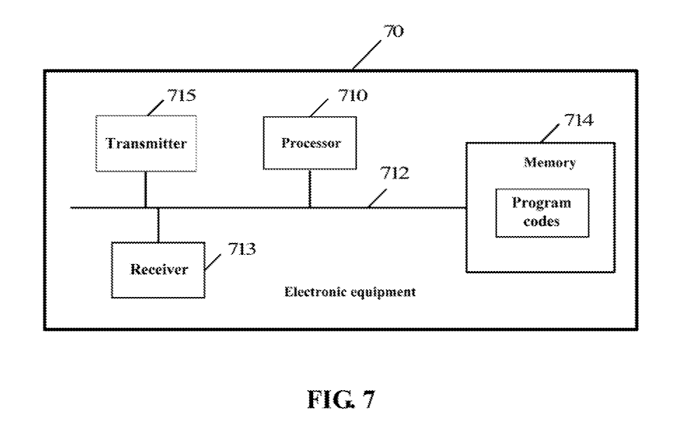

Moreover, as shown in FIG. 7, an embodiment of the present disclosure discloses electronic equipment 70. The electronic equipment 70 includes any one device for switching a name of a desktop icon folder in the above embodiments. As the electronic equipment includes any one device for switching a name of a desktop icon folder in the above embodiments, thus, the electronic equipment can control starting a folder name switching process when a preset event is detected, including: determining a system language used by current equipment firstly; searching for a folder name corresponding to a language category of the system language from data of desktop icon folder names previously input by a user, and switching a name of a desktop icon folder to the folder name corresponding to the language category of the system language. The electronic equipment can automatically determine the system language periodically or triggered by other preset events, according to preset configurations; and control an adaptive change of the name of the desktop icon folder according to a determination result, to make a changed name of the desktop icon folder be coordinated and consistent with names of other icons and be conveniently for the user to use.

In an embodiment of the present disclosure, the electronic equipment 70 can be different types of electronic equipment, such as a smart phone, a tablet computer, a handheld computer, a mobile Internet device, a personal digital assistant, a media player, an intelligent television, an intelligent watch, intelligent glasses, an intelligent bracelet, etc.

As shown in FIG. 7, the electronic equipment 70 in the embodiment of the present disclosure includes: at least one processor 710, such as a central processing unit (CPU), at least one receiver 713, at least one memory 714, at least one transmitter 715 and at least one communication bus 712. The communication bus 712 is used for realizing a connection communication among these components. The receiver 713 and the transmitter 715 may be wired transmission ports, and can also be wireless equipment, for example, including an antenna device for performing a data communication with other equipment. The memory 714 can be a high-speed random access memory (RAM) or a non-volatile memory, such as at least one magnetic disk storage.

The processor 710 can execute an operating system of the electronic equipment 70, various types of application programs, and program codes etc., for example, various modules as mentioned above including the name acquisition module 601, the detection module 501, the process control module 502, the process execution module 503 etc.

The memory 714 stores program codes, and the processor 710 can invoke the program codes stored in the memory 714 through the communication bus 712, to execute related functions. For example, the various modules as mentioned in FIG. 5 and FIG. 6 (e.g., the name acquisition module 601, the detection module 501, the process control module 502, and the process execution module 503 etc.) are program codes stored in the memory 714, and can be executed by the processor 710, so as to realize function of each module to realize processing of short messages.

In an embodiment of the present disclosure, the memory 714 stores a plurality of instructions, the plurality of instructions are executed by the processor 710 to achieve the method for switching a name of a desktop icon folder. Specifically, when a preset event is detected, the processor 710 starts a folder name switching process. The folder name switching process includes: determining a system language adopted by current equipment. The processor 710 searches for a folder name corresponding to a language category of the system language from data of desktop icon folder names previously input by a user; if the folder name is found, the processor 710 switches a name of the desktop icon folder from a first name to a second name; the first name and the second name are different in language category; the second name is a folder name corresponding to the language category of the system language.

In a further embodiment, the processor 710 also acquires at least one group of folder name data input by the user, when creating a desktop icon folder or modifying a folder name; and the at least one group of folder name data includes language category information and a corresponding folder name.

In a further embodiment, the at least one group of folder name data includes folder name data corresponding to the language category of a system default language.

In a further embodiment, when the folder name corresponding to the language category of the system language is not found, the processor 710 further switches the name of the desktop icon folder to a folder name corresponding to the language category of the system default language.

In a further embodiment, the preset event includes that:

a system periodic time node is reached, the system starts or the system executes a system language switching operation.

Specifically, specific implementation method of the instruction executed by the processor 710 can be referred to descriptions of relevant steps in the corresponding embodiments of FIG. 1 to FIG. 4, and it is not repeated herein.

Various embodiments in the specification are described in a progressive manner, emphasis of each embodiment describes differences with other embodiments, the same or similar descriptions of the various embodiments of the present disclosure can be referred to each other. For the device disclosed by the embodiments, as it corresponds to the method disclosed by the embodiment, thus, the descriptions are simple and relevant descriptions can be referred to the method.

It also should be noted that, in the specification, relation terms such as first and second, are only used to distinguish one entity or one operation from another entity or another operation, and it is not required or implied any actual relationship or sequence exists between the entities or the operations. Moreover, the terms “includes,” “including” or any other variants thereof are intended to a non-exclusive inclusion, so that a process, a method, an object or equipment including a series of elements not only include those elements but also include other elements not explicitly listed, or further include inherent elements of the process, the method, the article or the equipment. Under the condition that no more limitation exists, elements limited in a statement “includes an . . . ” does not exclude other same elements to be also existed in the process, the method, the article and the equipment.

The steps of methods or algorithms described in connection with the embodiments disclosed in the specification, may be directly implemented by hardware or software modules executed by the processor, or a combination of the hardware and the software modules. The software modules can be embedded in a RAM a memory, a read-only memory (ROM), an electrically programmable ROM, an electrically erasable programmable ROM, a register, a hard disk, a removable magnetic disk and a CD ROM, or any other form of storage medium known in the technical field.

The above description of the disclosed embodiments enables one skilled in the art to realize or use the present disclosure. Various modifications to these embodiments is apparent to those skilled in the art, general principles defined herein may be realized in other embodiments, without departing from the spirit or scope of the present disclosure. Accordingly, the present disclosure will not be limited to the embodiments shown herein, and is conformed to the widest scope that is consistent with the principles and novel features disclosed herein.

What is claimed is:

1. A method for switching a name of a desktop icon folder, executed by electronic equipment, comprising:
starting a folder name switching process when a preset event is detected;
the folder name switching process comprising:
determining a system language used by the electronic equipment;
searching for a folder name corresponding to a language category of the system language from data of desktop icon folder names previously input by a user; and
when the folder name is found, switching a name of a desktop icon folder from a first name to a second name, language categories of the first name and the second name being different, and the second name being the folder name corresponding to the language category of the system language.

2. The method for switching a name of a desktop icon folder of claim 1, further comprising:
when creating the desktop icon folder or modifying a folder name, acquiring at least one group of folder name data input by the user, the at least one group of folder name data comprising language category information and a corresponding folder name.

3. The method for switching a name of a desktop icon folder of claim 2, wherein the at least one group of folder name data comprises folder name data corresponding to a language category of a default system language.

4. The method for switching a name of a desktop icon folder of claim 3, wherein the folder name switching process further comprises:
when no folder name corresponding to the language category of the system language is found, switching the name of the desktop icon folder to the folder name corresponding to the language category of the default system language.

5. The method for switching a name of a desktop icon folder of claim 1, wherein the preset event comprises that:
a system periodic time node is reached, the system starts or executes a system language switching operation.

6-10. (canceled)

11. Electronic equipment, comprising:
a processor; and
a memory storing a plurality of instructions, which when executed by the processor, causes the processor to:
start a folder name switching process when a preset event is detected;
the folder name switching process comprising:
determining a system language used by current the electronic equipment;
searching for a folder name corresponding to a language category of the system language from data of desktop icon folder names previously input by a user; and
when the folder name is found, switching a name of a desktop icon folder from a first name to a second name, language categories of the first name and the second name being different, and the second name being the folder name corresponding to the language category of the system language.

12. The electronic equipment of claim 11, wherein the processor further:
when creating the desktop icon folder or modifying a folder name, acquires at least one group of folder name data input by the user, the at least one group of folder name data comprising language category information and a corresponding folder name.

13. The electronic equipment of claim 12, wherein the at least one group of folder name data comprises folder name data corresponding to a language category of a default system language.

14. The electronic equipment of claim 13, wherein the folder name switching process further comprises:
when no folder name corresponding to the language category of the system language is found, switching the name of the desktop icon folder to the folder name corresponding to the language category of the default system language.

15. The electronic equipment of claim 11, wherein the preset event comprises that:
a system periodic time node is reached, the system starts or executes a system language switching operation.

16. A non-transitory storage medium having stored thereon instructions that, when executed by a processor of electronic equipment, causes the processor of the electronic equipment to perform a method for switching a name of a desktop icon folder, the method comprising:
starting a folder name switching process when a preset event is detected;
the folder name switching process comprising:
determining a system language used by the electronic equipment;
searching for a folder name corresponding to a language category of the system language from data of desktop icon folder names previously input by a user; and
when the folder name is found, switching a name of a desktop icon folder from a first name to a second name, language categories of the first name and the second name being different, and the second name being the folder name corresponding to the language category of the system language.

17. The non-transitory storage medium according to claim 16, wherein the method further comprises:
when creating the desktop icon folder or modifying a folder name, acquiring at least one group of folder name data input by the user, the at least one group of folder name data comprising language category information and a corresponding folder name.

18. The non-transitory storage medium according to claim 17, wherein the at least one group of folder name data comprises folder name data corresponding to a language category of a default system language.

19. The non-transitory storage medium according to claim 18, wherein the folder name switching process further comprises:
when no folder name corresponding to the language category of the system language is found, switching the name of the desktop icon folder to the folder name corresponding to the language category of the default system language.

20. The non-transitory storage medium according to claim 16, wherein the preset event comprises that:
a system periodic time node is reached, the system starts or executes a system language switching operation.
